(19) United States
(12) Patent Application Publication
(10) Pub. No.: US 2008/0255704 A1
(43) Pub. Date: Oct. 16, 2008

(54) Control System and Teach Pendant For An Industrial Robot

(76) Inventor: Knut Braut, Sandnes (NO)

Correspondence Address: ST. ONGE STEWARD JOHNSTON & REENS, LLC, 986 BEDFORD STREET, STAMFORD, CT, 06905-5619, US

(21) Appl. No.: 12/098,245

(22) Filed: Apr. 4, 2008

Related U.S. Application Data
(63) Continuation of application No. PCT/IB2005/002965, filed on Oct. 5, 2005.

(51) Int. Cl. B25J 13/02; B25J 5/02; B25J 19/06; B25J 15/00

(52) U.S. Cl. 700/264; 901/4; 901/42; 901/43; 901/36

(57) ABSTRACT

A robot controller for an industrial robot is described. The robot controller is a portable controller of the TPU Teach Pendant Unit type and comprises control means for moving a robot in three or more degrees of freedom. The TPU comprises a visual display and selection means associated with programming or controlling a robot. In other aspects of the invention a system comprising a robot and a control unit and the TPU are described. A computer program of the TPU for carrying out the method is also provided.

### CROSS-REFERENCE TO RELATED APPLICATIONS

The present application is a continuation of pending International patent application PCT/IB2005/002965 filed on Oct. 5, 2005 which designates the United States and the content of which is incorporated herein by reference.

### FIELD OF THE INVENTION

The invention relates to a control system for an industrial robot of the kind comprising a portable robot controller or teach pendant including a control means for manually controlling movement of a robot or manipulator arm. In particular the invention relates to an improved teach pendant unit (TPU).

### BACKGROUND OF THE INVENTION

Manually controlled movement of a robot arm—is used especially during a programming stage in order to teach the robot to follow an operating path defined by a number of set points. A memory means in the control system may store the coordinates of said set points as position instructions and other operating instructions which, together with said set points, may define a work cycle of the robot and means arranged, during automatic running of the robot, to control the robot in accordance with information stored in the memory means during the programming stage.

In a control system for an industrial robot, the robot during programming is often run with the aid of the first control means, which can be manually influenced, a means such as a joystick. The robot or end effector of the robot is successively moved to each of said set points or waypoints which define the movement path or the operating positions that the robot is to follow or assume during automatic operation. These positions may be stored in the form of a sequence of position instructions in a program memory, i.e. the memory means, present in the robot, or in a control unit. In addition to the pure position instructions, other operating instructions are stored in the program memory giving further information about the working cycle of the robot. For example the operating instructions may give information about the desired robot velocity in a certain section of the movement, about control of outputs from the robot to external equipment, about a desired precision of the robot movement, about conditions for the robot movement in dependence on input signals from external sensors or equipments, about events such as switch on/off paint spray, about calls for pre-programmed subroutines, and so on. During automatic operation of the robot, the program instructions are run through successively, and the robot is displaced successively between the different programmed positions in accordance with the position instructions and further carries out the measures which are programmed into the instructions.

U.S. Pat. No. 4,888,708 to Brantmark entitled Control system for an industrial robot describes a portable unit or teach pendant unit for manual control of the robot during programming for teaching the robot to follow a trajectory or working path defined by a number of set points. The TPU described comprises a joystick arranged for controlling the movement of the robot as well as other control means with a plurality of other control functions.

The TPU described as shown in U.S. Pat. No. 4,888,708 FIG. 1 (Prior Art) is normally held in, for example, the left hand, so that an operator would rest the teach pendant in part on his/her left forearm. If the TPU is held in this example left the hand then the operator may take the joystick in his/her right hand, and the operator may then move the joystick in the x or y direction, causing the robot to moving the x or y direction, and rotate the shaft of joystick to cause a movement of the robot in the z direction. The operator may hold the TPU with eg the left hand and at the same time must press down with the fingers of the left hand on a safety plate 22. The function of the safety plate is to ensures that the TPU is operable and that when the safety plate is not being held down by the operator the robot does not move if the joystick is moved accidentally. However by todays standards the TPU is relatively large and heavy. The operator may tend to experience fatigue in the hand holding the safety switch, and/or the other hand operating the joystick during a long programming cycle. It is important that operator fatigue should be avoided for many reasons, and especially because the risk that an operator may make a mistake increases with fatigue.

The present invention aims to provide an improved teach pendant for a control system for an industrial robot of the kind mentioned above.

### SUMMARY OF THE INVENTION

According to an embodiment of the present invention there is provided an improved control system of the kind referred to wherein the portable robot control means comprises at least two control means of the 2-axis type, preferably joysticks, for controlling the movement of the robot. According to another embodiment of the present invention there is provided an improved portable robot control means comprising at least two control means of which a first joystick means controls of movement of a robot or manipulator arm in at least one first (x) and/or one second (y) axis and where joystick means controls movement of said robot or manipulator arm in at least one other (z) axis.

According to another embodiment of the present invention there is provided an improved portable robot control means comprising at least two control means of which at least one first joystick is a thumb-operated joystick arranged with manipulation means for the thumb one first hand.

According to another embodiment of the present invention there is provided an improved portable robot control means comprising at least two control means both which are joystick control means of the same type.

According to another embodiment of the present invention there is provided an improved portable robot control wherein the controller or TPU comprises at least two areas for holding or gripping the TPU panel, at least two of which arranged on opposite sides of the TPU, such that the one first joystick is arranged within reach of a one first hand and operable using the thumb of the one first hand and the second joystick arranged within reach of the second or other hand and operable using the thumb of the second other hand whilst holding the TPU with the second hand.

According to another embodiment of the present invention there is provided an improved portable robot control wherein the controller or TPU comprises software configuration means for selecting or configuring which degree or degrees of freedom or axis direction of the robot, or of a system including the robot, each joystick shall be arranged to control. The TPU may be configured to control movement of the robot in a fourth (R) axis.

According to another embodiment of the present invention there is provided an improved portable robot control wherein the controller or TPU comprises a live handle switch complying with an industrial safety standard arranged to control robot movement so as to stop movement in the event that the operator does not hold the live handle switch in a run position. In another embodiment the live handle switch is arranged connected to a first and a second safety switch operating means arranged such that the robot may be moved if one safety switch operating means only is held in the a run position, and such that robot movement stops if neither safety switch operating means is held in the run position.

According to another embodiment of the present invention there is provided an improved portable robot control wherein the controller or TPU comprises at least one joystick means are arranged with a switch means operable by pressing the joystick down or up in a vertical direction, or along a direction of the long axis of the joystick. In another embodiment the improved robot controller is arranged with configurable or programmable means to select a function or functions which are operable by the up/down switch of the first and/or of the second joystick. In another embodiment the improved robot controller is arranged with configurable or programmable means to select which job mode or modes the TPU shall operate in by pressing or influencing an up/down switch of the first and/or of the second joystick. In another embodiment the improved robot controller is arranged with configurable or programmable means wherein the switch means operable by an up or down movement of the joystick may be arranged configured to switch on or off any from the list of: a robot tool, a robot end-effector. In another embodiment the improved robot controller is arranged configurable or programmable wherein the switch means operable by an up or down movement of the joystick may be arranged configured to switch on or off equipment arranged around the robot including any from the list of: colour changer device, air supply, an actuator, a tool, a tool-changer, a turntable or a jig.

According to an embodiment of the present invention there is provided one or more methods for moving or controlling a robot or manipulator arm using an improved robot controller or teach pendant comprising a first joystick of said teach pendant and moving or controlling a movement of a robot or manipulator arm in a first (x) and/or second (y) axis by moving the first joystick with one first hand and by moving or controlling a movement of the robot or manipulator arm in a third or z direction.

According to another embodiment of the present invention there is provided one or more methods for moving or controlling a robot or manipulator arm using an improved robot controller or teach pendant in a fourth direction, for example along a track or rail, by manipulating the second joystick means.

According to another embodiment of the present invention there is provided a method for moving or controlling a robot or manipulator arm using an improved robot controller or teach pendant by configuring the TPU to arrange control either of the first joystick or the second joystick to control any one or two of at least four available axes (x, y, z, R) of movement.

According to another embodiment of the present invention there is provided one or more methods for moving or controlling a robot or manipulator arm using an improved robot controller or teach pendant by holding or urging at least one live handle switch operating means so that it is held in a run position to move or control the robot by the operator.

According to another embodiment of the present invention there is provided one or more methods for moving or controlling a robot or manipulator arm using an improved robot controller or teach pendant by pressing or urging the joystick in a downward vertical direction and activating a switch. In another embodiment of the present invention a method is provided whereby the TPU is configured to arrange control by the first joystick or second joystick for switching on or off, by means of a press or click of a joystick in a downward or vertical direction, an end-effector or tool mounted on the robot or arm. In another embodiment of the present invention a method is provided whereby the TPU is configured to arrange control of movements while in Jog mode by means of clicking the first or second joystick.

According to another embodiment of the present invention there is provided a system for moving or controlling a robot or manipulator arm using an improved robot controller or teach pendant further comprising said robot controller or teach pendant, a robot control unit arranged for control of at least one a robot or manipulator and wherein movement of the robot arm may be controlled by the TPU comprising two bi-directional joystick means, wherein said controller or TPU comprises a second and bi-directional joystick means for control of said robot or manipulator arm in at least one other axis.

According to another embodiment of the present invention there is provided one or more computer programs comprising computer code means and/or software code portions for making a computer or processor control a process of moving or programming an industrial robot using a first and a second joystick means of the TPU.

The improved robot controller according to an embodiment of the invention proposes a new way for moving a robot to a desired point by means of using with two simple 2-axis joysticks. The robot controller provides for mapping up to 4 axes of the robot at any one time and moving the robot using the thumb operated joysticks. The improved portable robot controller or TPU comprising two joysticks offers the advantage of considerably improved ease-of-use when compared to the prior art devices. In part, the effort required to program the robot is reduced because the movement control task may be shared between two hands as required. An important technical advantage of the improved design is that the improved TPU permits the operator to move the robot in a direction in space represented by at least 3 degrees of freedom by moving the two joysticks simultaneously in a coordinated movement. When in angle mode, the operator can change the angle of attack of the robot by moving both joysticks. The improved TP also provides the user with a simpler and easier comfortable method to jog the robot. The advantage of all these features provided by the dual joystick control arrangement is that use of the robot controller is less fatiguing for the operator.

A very significant advantage of the improved robot controller according to an embodiment of the invention is provided by comprising a safety means arranged to permit an operator to operate the robot controller using one hand only. This is also a feature that provides opportunities to reduce operator fatigue. This feature also permits a changeover of operation from one hand to the other hand such that control of the robot does not have to be interrupted. This is because the safety arrangement provides two live handle switch operating means, one being located within reach of the left hand and the other one within reach of the right hand. Thus the operator can hold one first live handle switch operating means, grip the second live handle switch operating means with the other hand, and then let go of the first live handle switch operating means, and control the robot with the second means. By doing so the operator can change hands or take away either hand from the TPU without interrupting control. The above new features of improved TPU offer considerably improved ease-of-use for an operator and also contributes to significant reductions in operator fatigue.

Another advantage of the improved TPU according to an embodiment is that the joystick may be configured or re-configured in the TPU or robot control software to assign movement axes to each joystick to suit the preferences of operators, and to easily change preferences for example for operators who are left handed or right handed. Another advantage is that the TPU may control up to 4 axes at a time, but the selection and distribution of axes such as x, y, z, and a fourth axis may be varied by configuring the TPU in the TPU or other robot control software. Commonly the left joystick may be selected to move the robot in the x and y directions, and the right joystick selected to move the robot in the z direction. When a fourth axis is present, when the robot is for example rail or track or mounted, trolley mounted, or moveable in some other way, a rail axis may be selected as a fourth axis R on, for example, the right joystick.

### BRIEF DESCRIPTION OF THE DRAWINGS

A more complete understanding of the method and system of the present invention may be had by reference to the following detailed description when taken in conjunction with the accompanying drawings wherein:

FIG. 1 shows a schematic diagram of an improved portable robot controller or TPU as seen from above according to an embodiment of the invention,

FIG. 2 shows a schematic diagram of an improved portable robot controller or TPU as seen from one side according to an embodiment of the invention,

FIG. 3 shows a schematic overview diagram for a robot control system comprising a robot, portable robot controller or TPU and a robot control unit, according to an embodiment of the invention,

FIG. 4 shows a schematic three-dimensional view of an improved portable robot controller or TPU according to an embodiment of the invention,

FIG. 5 shows a schematic diagram of an improved portable robot controller or TPU as seen from below according to an embodiment of the invention,

FIG. 6 shows schematically a flowchart for a method of operating an improved portable robot controller or TPU according to another embodiment of the invention.

### DETAILED DESCRIPTION OF THE INVENTION

In an embodiment of the present invention an improved TPU is described for moving a robot by means of manually influencing at least two control means, such as joysticks, and in particular, bi-directional control means or joysticks.

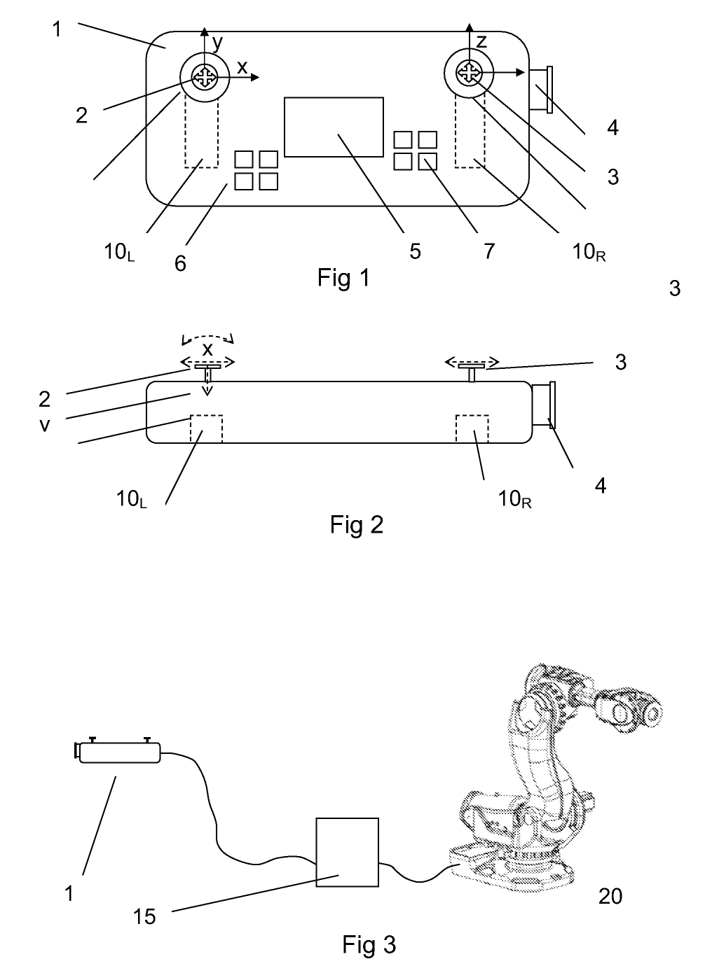

FIG. 1 shows a schematic view from above of the improved TPU of an embodiment of the invention much as an operator looking down may see it. The figure shows a TPU in the form of a panel 1 or console, including a first control means 2 and a second control means 3. An emergency stop 4 is arranged as a push button on the panel. The panel may be further arranged with a display 5 of some sort and one or more switch means 6, 7. The switch means 6 or 7 may be arranged as single pushbuttons or groups of pushbuttons. The functions of the pushbuttons are controlled by the robot control system and may be presented in plain text on the display. The pushbuttons may activate fixed functions or variable eg programmable functions. Generally each pushbutton when activated displays to the operator information about what measures are permitted at each moment.

For example while jogging the robot the display may show information such as:

when jogging in a Cartesian setting: Jog mode (xyz or angles), current position and angular orientation, which Work object position values are referred to, which tool is engaged.

when jogging in an axis by axis setting: Jog group (axes 1, 2, 3/4, 5, 6/trolley), angle value per axis. In Jog mode the robot or arm may be moved or jogged by means of clicking the built in switch on the first or the second joystick.

Joystick direction advisors, possible locked joystick directions (for example not to risk touching fragile surfaces or tooltip),

Enabling device status,

Emergency stop status,

motors on/off status.

While running production the display may show information such as:

Current playing program (or stopped within) with process data, next program to be played, object position and speed.

If stopped, cause of stop (if known) is displayed, eg. run chain broken, emergency stop etc.

The function pushbuttons may be used to control aspects such as: the sequence in which instructions, program sections or programs are carried out; communication between the robot system and other external or peripheral equipment; determining certain conditions for the mode of operation of the robot axes; information about which axes are configured to which joystick and options for re-configuring a selection. Functions such as Run-step-stop may be controlled by dedicated buttons on the key-foil or other button means of the TPU. Any programmed functionality (I/O, utility programs) can be engaged by a “programmable button”.

Control means 2, preferably a joystick, is mounted with its vertical axis perpendicular to the panel. It may be moved or manually influenced in a direction that may be represented as a movement with two degrees of freedom. This movement is indicated in the diagram by arrows labeled X and Y. The second control means, which also is preferably a joystick, may also be moved or manually influenced in a direction that may be representing a movement with up to two degrees of freedom. For example one direction may be configured to control or move the robot in a vertical or z axis direction, even though in real time the operator also moves the second joystick generally in an x or y direction.

FIG. 2 shows an improved TPU as viewed from one side. The control means 2, 3 are preferably formed with a relatively flat operating part at the upper end of the joystick as indicated. The top of the joystick may be moved in a horizontal plane using one thumb pressing lightly on the flat part, in a direction as indicated X by a straight double 'arrow or in a plane representing a somewhat curved surface, as indicated by the curved arrow. In addition, each or both control joysticks may be arranged with a switch which is activated by pressing down on the joystick, as indicated by vertical arrow V in the figure. On the underside of the TPU panel are arranged a first live handle switch operating means 10L and a second live handle switch operating means 10R. These will be described in more detail below.

FIG. 3 shows an overview of an improved TPU of an embodiment of the invention and a robot control unit and a robot. The robot is controlled by a control unit, which is connected to the robot by a cable for transfer of data communication. The TPU is connected by cable to the robot control unit although, arranged such that safety arrangements are satisfied, the TPU may communicate by with the control unit using a wireless means. The robot 20 may be moved and controlled by the TPU 1 by means of the robot control unit 15.

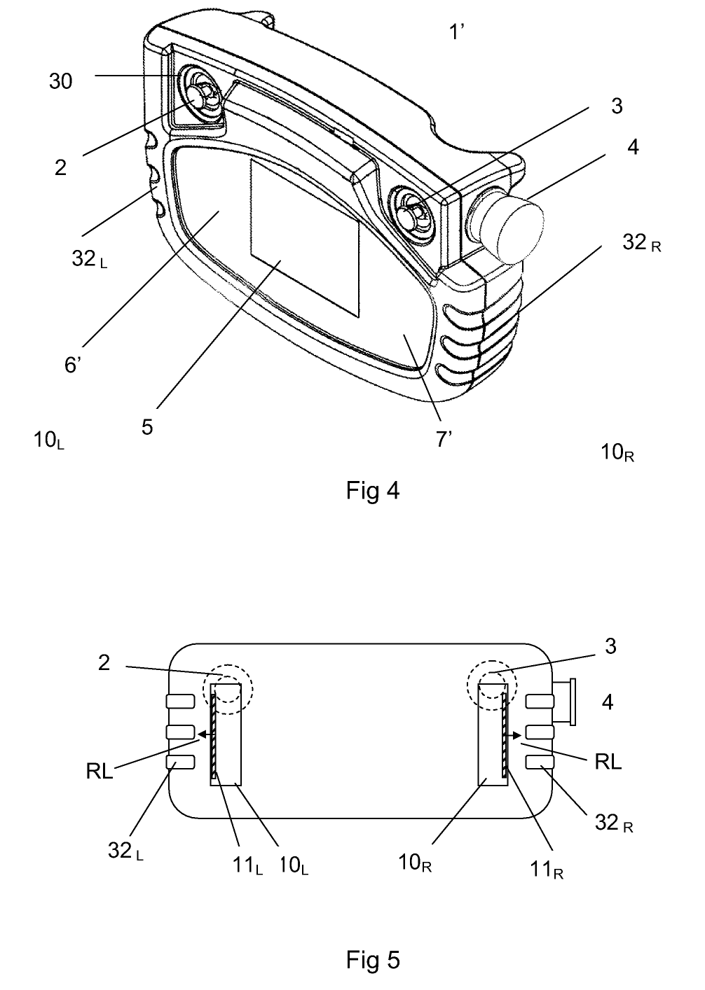

FIG. 4 shows a 3-D view of the improved TPU of an embodiment of the invention. The figure shows a TPU in the form of a portable panel 1′ arranged with a first 2 joystick and a second 3 joystick. The joysticks are shaped with a substantially flat top surface as previously indicated in FIGS. 1, 2. The figure also shows an emergency stop button 4 and a display 5. The TPU is also shown formed with a handgrip pattern on two sides. The handgrip patterns on the TPU are advantageous to make it easier to grip and hold the TPU. An operator normally holds the TPU shown in FIG. 4 with the left handgrip 32L in the left hand and right handgrip 32R in the right hand. Left joystick 2 is then in reach of at least the thumb of the left hand and right joystick 3 is conveniently arranged in reach of the thumb of the right hand.

In another embodiment of the improved TPU a live handle switch is included in the TPU. The live handle switch may be of the certified safety switch type as described in U.S. Pat. No. 5,444,203 to Gunnarsson assigned to ABB entitled Safety Switch for an Industrial Machine. The above disclosure describes a three position safety switch, which specification is hereby incorporated in this description in full by means of this reference. The safety switch is operable from a first end position via an operating position to a second end position, <′> the safety circuit being closed only in the operating position. During the return movement from second position to the first end position, the contact device is not affected, and the safety circuit thus remains open during the whole of this return movement.

At least one of the live handle switch operating means handles HL, HR arranged to operate the safety switch may be regarded as a form of enabling device within the context of robot control, and portable robot control units in particular.

The operator may hold the TPU in, say, the left hand about handgrip 32L and at the same time press the safety switch operating means 11L substantially in the direction indicated RL with fingers of the same hand, so holding the live handle in the run position, and may also operate the left joystick 2 using the left thumb. At the same time with the TPU held and operated in the left hand, the right hand may be free, the right hand may hold the TPU, or the right hand hold the TPU and operate the right joystick 3. The operator can hold the TPU in the right hand and remove the left hand as soon as the fingers of the right hand presses the safety switch operating means HR, for example in the direction RR. That is to say that so long as one of the safety switch operating means HR or HL is held by the operator the robot can be moved. The great advantage of the improved TPU is that the operator can operate the TPU with one hand, hold the TPU in one hand and then change it to the other hand without stopping movement control of the robot.

At least one joystick may be arranged so that it is returned to its neutral position by resilient members, with a certain minimum force being required to displace the joystick from its neutral position. The velocity of the robot movement may determined by the deflection of the joystick from its neutral position in each axis. The or either joystick may be arranged with mounting means for the joystick to be movable in at least three degrees of freedom for controlling the robot. The joystick or mounting means may comprise three transducers, for example potentiometers, which sense the deflection of the joystick. The joystick deflection may be converted into digital signals. The TPU is preferably arranged to suit explosion proof standards, by for example limiting the maximum value of available electrical current and by avoiding exposure of “hotspots” to the surrounding air. The mounting means, joystick mechanics and electrical components may for also be sealed from contact with the surrounding air or for protection from contact with dust and solvents.

The display is preferably a LCD (Liquid Crystal Display) but may be any other safe means, vacuum tube display, plasma screen, pixel display etc and/or including touch sensitive screen materials. The display provides the operator with information which may be in a text form and/or with graphics for informing the operator: what measures or actions are currently permitted, jog mode in terms of eg xyz or angles, current position and angular orientation, which Work object position values are referred to, which tool is engaged, Jog group when in axis by axis mode out of axes 1, 2, 3/4, 5, 6/R or trolley (when jogging in an axis by axis setting), angle value per axis.

Other information may comprise simulation or calculation features such as: Joystick direction advisors, which joystick directions are possible to lock, for example to reduce risk of touching a fragile surface or a tool tip, and important status and safety state information such as: Enabling device status, Emergency stop status, Motors on/off status.

The improved TPU may be used to program and control an industrial robot or manipulator arm to carry out one or more of many tasks, including any task from the list of: gripping an object, manipulating an object, stacking, pick and place objects, controlling and operating an amusement ride or an installation comprising a human passenger, welding, framing a vehicle body, riveting, de-burring, fettling, grinding, coating, painting, applying sealant, applying glue, dry spraying, gluing, folding plate, bending plate, hemming plate.

In another embodiment at least one of the control means 2, 3 of the TPU may comprise any from the list of: joystick, trackball, trackpoint, mechanical mouse, optical or opto-mechanical computer mouse, touch pad or glide point.

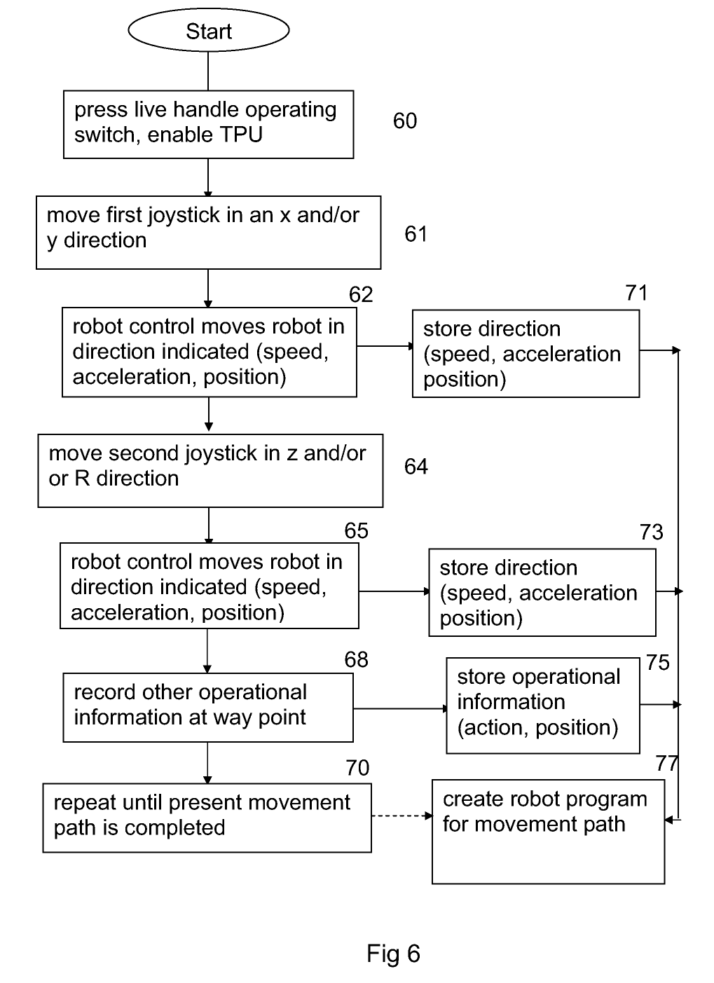

FIG. 6 shows a flowchart for operating an improved portable robot controller or TPU according to another embodiment of the invention. The flowchart shows steps of:

60 press live handle operating switch, enable TPU 61 move first joystick in x and/or y direction

62 robot control moves robot in direction indicated
the robot control unit provides signals to activate motors or actuators to move the robot, or a least the end effector of the robot, in the direction indicated by manipulating the first joystick, recording the speeds, acceleration and/or positions;

71 store direction (speed, position)
the end effector position at least is stored in terms of vector data or coordinate data for use in programming the desired movement path;

64 move second joystick in z and/or R direction 65 robot control moves robot in direction indicated (record speed, position)
the robot control unit activates motors or actuators to move the robot, or a least the end effector of the robot, in the direction indicated by manipulating the second joystick and records the speeds, acceleration and/or positions;

73 store direction (speed, position)
the end effector position at least is stored in terms of vector data or coordinate data for use in programming the desired movement path;

68 record other operational information at way point
information such as switch on/off paint at this setpoint or waypoint, by for example, clicking a joystick button in the vertical axis;

75 store operational information (action, position)
operational information is stored relative the vector data or coordinate data for use in programming the desired movement and control path;

69 repeat until present movement path is completed
the robot is moved along a path until the desired path and/or operational steps have been carried out and data based on speed, acceleration, co-ordinate data, and end effector position in six degrees of freedom etc. have been recorded.

A further step may also be carried out, namely, to create a program:

77. create robot program for movement path
as required, a program for automatic movement of the robot is created, or an already existing program modified, dependent on the movements, waypoint positions and operational information which were generated, recorded and stored using the above method.

In another embodiment of the invention the safety switch operating means IIL or HR may be urged in another direction than RL or RR in order to enable use of the TPU.

In another aspect of the invention a computer program is described for carrying out the method or methods according to the invention. In another aspect of the invention a computer program product comprising a computer program for carrying out the method of the invention is described. In another aspect of the invention a computer data signal embodied in a carrier wave is described. In another, further aspect of the invention a graphical user interface is described for displaying mode or configuration or programming information for robot controlled by the TPU.

The TPU may comprise one or more microprocessors or processors. The microprocessor (or processors) of the TPU comprises at least one central processing unit CPU performing the steps of one or more methods according to an aspect of the invention. These control processes and methods are performed with the aid of one or more computer programs, which are stored at least in part in memory such as memory means accessible by the processor. It is to be understood that the computer programs carrying out methods according to the invention may also be run on one or more general purpose industrial microprocessors or computers, or on one or more specially adapted computers or processors, FPGAs (field programmable gate arrays) or ASICs (application specific integrated circuits) or other devices such as simple programmable logic devices (SPLDs), complex programmable logic devices (CPLDs), field programmable system chips (FPSCs).

The computer program comprises computer program code elements or software code portions that make the computer perform the described methods, such as those shown in FIG. 6, using equations, algorithms, data, storing data retrieving data and making calculations as previously described. A part of the program may be stored in a processor of the TPU as above, but also in a ROM, RAM, PROM EPROM or EEPROM chip or similar memory means. The program in part or in whole may also be stored on, or in, other suitable computer readable medium such as a magnetic disk, CD-ROM or DVD disk, hard disk, magneto-optical memory storage means, in volatile memory, in flash memory, as firmware, or stored on a data server. Removable memory media such as removable hard drives, bubble memory devices, flash memory devices and commercially available proprietary removable media such as the Sony memory stick and memory cards for digital cameras, video cameras and the like may also be used.

The computer programs described may also be arranged in part as a distributed application capable of running on several different computers or computer systems at more or less the same time.

It should be noted that while the above describes exemplifying embodiments of the invention, there are several variations and modifications which may be made to the disclosed solution without departing from the scope of the present invention as defined in the appended claims.

1. A robot controller or teach pendant comprising a first joystick means for bi-directional control of movement of a robot or manipulator arm in at least one first (x) and/or one second (y) axis, characterised in that said controller or TPU comprises a second and bi-directional joystick means for control of said robot or manipulator arm in at least one other (z) axis.

2. A robot controller according to claim 1, wherein at least one first joystick is arranged with lever means for manipulation using the thumb or other digit of one first hand.

3. A robot controller according to claim 1, wherein the second joystick is arranged with lever means for manipulation using the thumb or other digit of the other hand.

4. A robot controller according to claim 1, wherein the controller or TPU comprises a panel with a handle means for holding the TPU using the one first hand arranged closer to the first joystick means than the second joystick means, on a opposite side of the TPU and at least one first joystick arranged positioned on the TPU within reach of a one first hand and to be operable using the thumb of the one first hand whilst holding the TPU with the first hand.

5. A robot controller according to claim 4, wherein the controller or TPU comprises a panel with at least handle means for holding the TPU wherein a holding
handle for each hand is arranged on opposite sides of the TPU, such that the one first joystick is arranged positioned on the TPU within reach of a one first hand and to be operable using the thumb of the one first hand and the second joystick arranged positioned within reach of a second other hand and to be operable using the thumb of the second other hand whilst holding the TPU with the second hand.

6. A robot controller according to claim 5, wherein the controller or TPU comprises two joysticks each arranged with lever means for manipulation by a thumb of each hand wherein the TPU has a selection means for configuring the first joystick may be arranged to control movement in a first (x) axis and/or a second (y) axis and the second or other joystick may be arranged for movement control in a third (z) axis.

7. A robot controller according to claim 1, wherein the controller or TPU comprises configuration means for selecting or configuring which degree or degrees of freedom or axis direction of the robot each joystick shall be arranged to control.

8. A robot controller according to claim 7, wherein the second or other joystick may be arranged to control movement of the robot in a fourth (r) axis.

9. A robot controller according to claim 8, wherein the fourth (r) axis may comprise controlling a movement of the robot along a track or rail or by means of a trolley.

10. A robot controller according to claim 1, wherein the controller or TPU comprises at least one joystick means arranged with mounting means for the joystick to be movable in at least three degrees of freedom for controlling the robot.

11. A robot controller according to claim 1, wherein the TPU comprises a live handle switch complying with an industrial safety standard arranged to control robot movement so as to stop movement in the event that the operator does not hold the live handle switch in a run position.

12. A robot controller according to claim 11, wherein the live handle switch is arranged connected to a first and a second safety switch operating means arranged such that the robot may be moved if one safety switch operating means only is held in the a run position, and such that robot movement stops if neither safety switch operating means is held in the run position.

13. A robot controller according to claim 11, wherein the TPU comprises a live handle switch arranged with at least one first safety switch operating means is arranged on the TPU within reach of one first hand and operable by urging it in a generally horizontal direction.

14. A robot controller according to claim 1, wherein the TPU comprises two or more safety certified live handle switches.

15. A robot controller according to claim 1, wherein either the first and/or the second joysticks are arranged with a switch means operable by pressing the joystick in a down or up in a vertical direction or along a direction of the long axis of the joystick.

16. A robot controller according to claim 7, wherein the controller is arranged with configurable or programmable means to select which function or functions are operable by the up/down switch of the first and/or of the second joystick.

17. A robot controller according to claim 16, wherein the controller is arranged with programmable means to select which job mode or modes the TPU shall operate in by pressing or influencing an up/down switch of the first and/or of the second joystick.

18. A robot controller according to claim 15, wherein the switch means operable by an up or down movement of the joystick may be arranged configured to switch on or off any from the list of: an actuator, a tool, or a jig.

19. A robot controller according to claim 1, wherein the TPU comprises two joysticks each operable using a digit of each hand wherein each joystick may be arranged to control movement in a first or x axis and/or a second or y axis and the other joystick arranged for control in a third or z axis.

20. A robot controller according to claim 14, wherein the TPU comprises a live handle arranged with one handle means arranged within reach of one or more digits of one hand and a second handle means arranged within reach of the one or more digits of the second hand.

21. A robot controller according to claim 14, wherein the TPU comprises a first joystick means and a first handle means for operating a live handle switch both arranged with easy reach of the one first hand and the second joystick means and a second handle means for operating a live handle switch both arranged with easy reach of the second other hand.

22. A robot controller according to claim 1, wherein the TPU comprises a first joystick means including a data input means comprising any from the list of: joystick, thumb-operated joystick, trackball, trackpoint, mechanical, optical or opto-mechanical computer mouse, touch pad or glide point.

23. A robot controller according to claim 1, wherein the TPU comprising one or more computer programs comprising computer code means and/or software code portions for making a computer or processor control a process of moving or programming an industrial robot using a first and a second joystick means.

24. A robot controller according to claim 1, wherein the TPU comprises a display means.

25. A robot controller according to claim 24, wherein the TPU display means is arranged to display coordinate and/or angular position information for up to 4 movement direction axes (x,y,z,R) at a time.

26. A robot controller according to claim 24, wherein the TPU display means is arranged to display information about permitted movement for up to 4 movement direction axes (x,y,z,R) at a time.

27. A robot controller according to claim 24, wherein the TPU display means is arranged to display is arranged to display information about a mode such as any from the list of: run, run-step-stop, jog, enabled, not enabled.

28. A method for moving or controlling a robot or manipulator arm using a robot controller or teach pendant comprising a first joystick of said teach pendant and moving or controlling a movement of a robot or manipulator arm in a first (x) and/or second (y) axis by moving the first joystick with one first hand, characterised by a movement of said robot or manipulator arm in a third or z direction is controlled and by manipulating a second bi-directional joystick means arranged on the same teach pendant using a second other hand.

29. A method according to claim 28, wherein a movement of said robot or manipulator arm in an axis other than a first (x) or second (y) axis is controlled by manipulating a second joystick by means of a digit of the other hand.

30. A method according to claim 28, wherein a movement of said robot or manipulator arm in a third or z direction and movement of the robot in a fourth direction of another axis not being either of the first (x) or the second (y) is controlled by manipulating a second joystick means.

31. A method according to claim 28, wherein a movement of said robot or manipulator arm in a fourth direction (R) along a track or rail is controlled by manipulating the second joystick means.

32. A method according to claim 28, wherein configuring the TPU to arrange control either of the first joystick or the second joystick to control any one or two of at least four available axes (x, y, z, R) of movement.

33. A method according to claim 28, wherein the TPU is arranged with at least one live handle switch operating means and by the operator holding or urging at least one of them in a run position to enable the robot to be moved or controlled.

34. A method according to claim 28, wherein configuring the TPU to arrange control either of the first joystick means or the second joystick means of a function by means of a press or click of the joystick in a downward or vertical direction.

35. A method according to claim 28, wherein configuring the TPU to arrange control by the first joystick or second joystick for activating, by means of a press or click of a joystick such as in a downward or vertical direction, an end-effector or tool mounted on the robot or arm.

36. A method according to claim 35, wherein configuring the TPU to arrange control by the first joystick or second joystick for jogging the robot or arm, by means of a press or click of a joystick such as in a downward or vertical direction, while set in Jog mode.

37. A method according to claim 28, wherein configuring the TPU to arrange control by the first joystick or second joystick for activating a tool changer, paint colour changer, or jig arranged in the same working area as the robot and not mounted on the robot by means of a press or click of a joystick in a downward or vertical direction.

38. A method according to claim 28, wherein both joysticks are urged or manipulated at the same time and the robot is moved in one direction that may be represent by at least 3 degrees of freedom.

39. A method according to claim 28, wherein one or both joysticks may be manipulated or urged to change an angular movement to a different angle of attack when the TPU is selected in an angular movement mode.

40. A computer program comprising computer code means and/or software code portions for making a computer or processor perform any of the steps of claim 28.

41. A computer program product according to claim 40 comprised in one or more computer readable media.

42. A system comprising a robot controller or teach pendant comprising a first joystick means for bi-directional control of movement of a robot or manipulator arm and a robot or manipulator arm, a robot control unit arranged for control of at least one a robot or manipulator wherein movement of the robot arm is controlled by a TPU comprising two bi-directional joystick means, wherein said controller or TPU comprises a second and bi-directional joystick means for control of said robot or manipulator arm in at least one other (z) axis.

43. Use of a TPU according to claim 1 for programming or controlling a robot to carry out an application of non-conductive or electrically conductive fluid materials comprising any from the list of: paint, waterborne paint, primer, base coat, e-coat, top coat, clearcoat, paint component, 2k paint, protective coating, glue, adhesive, sealant.

44. Use of a system according to claim 42 for controlling or programming an industrial robot to carry out any task from the list of: gripping an object, manipulating an object, stacking, pick and place objects, controlling and operating an amusement ride or an installation comprising a human passenger, welding, framing a vehicle body, riveting, de-burring, fettling, grinding, coating, painting, dry spraying, gluing, folding plate, bending plate, hemming plate.
